(19) United States
(12) Patent Application Publication
(10) Pub. No.: US 2026/0266447 A1
(43) Pub. Date: Sep. 10, 2026

(54) A LUMINAIRE WITH A REFLECTOR COMPRISING MICROSTRUCTURES

(71) Applicant: SIGNIFY HOLDING B.V., EINDHOVEN (NL)

(72) Inventors: BARRY MOS, BOCHOLT (BE); HUGO JOHAN CORNELISSEN, ESCHAREN (NL); MARCUS THEODORUS MARIA LAMBOOIJ, EINDHOVEN (NL); DANIËL ANTON BENOY, GELDROP (NL); LOTTE BENTE ROMIJN, VALKENSWAARD (NL)

(21) Appl. No.: 19/166,593

(22) PCT Filed: Mar. 12, 2024
(86) PCT No.: PCT/EP2024/056508

§ 371 Date: Sep. 18, 2025

(30) Foreign Application Priority Data
Mar. 20, 2023 (EP) 23162770.4

(51) Int. Cl. F21V 7/04; F21V 3/04; F21V 7/00; F21Y 103/10

(52) U.S. Cl. CPC F21V 7/04; F21V 3/049; F21V 7/0008; F21V 7/005; F21Y 2103/10

(57) ABSTRACT

A luminaire having one or more linear light sources. A reflector carries microstructures that receive a portion of light emitted by each light source and redirect the received light such that it undergoes an angular change of from 140°up to, but not including, 180°. The microstructures are positioned between the light source(s) and a diffusive reflective surface.

### FIELD OF THE INVENTION

The present invention relates to the field of luminaires, and in particular to luminaires suitable for downlighting applications.

### BACKGROUND OF THE INVENTION

The use of artificial lighting is becoming increasingly common, with luminaires becoming more popular due to their high energy efficiency and flexibility of use. Luminaires are found in a wide variety of environments, including domestic, industrial, clinical, educational and/or office environments.

One type of luminaire that is becoming increasingly common makes use of one or more light sources to illuminate a reflector. The reflector redirects the light from the light source(s) out of a light exit window. In use, the light source(s) are positioned to be upwardly facing, with the reflector being positioned to be downwardly facing. The reflector often has an arc-shaped cross-sectional shape and has a diffusive reflective surface (e.g., is coated with white paint). The diffusive reflective surface reflects the light from the light source(s) in a diffusive manner, e.g., to have a Lambertian distribution.

An importation attraction of such concepts is the look-and-feel, as white surface gives a viewer a remarkable feeling of emission of light without seeing where the light comes from. In other words, such concepts are able to illuminate an environment with a uniform and wide light distribution.

There is an ongoing desire to improve the control of light output by such luminaire.

US2010172152A1 discloses an illumination system having a light exit window for emitting light from the illumination system.

### SUMMARY OF THE INVENTION

The invention is defined by the claims.

According to examples in accordance with an aspect of the invention, there is provided a luminaire comprising: a light exit window; one or more linear light sources positioned to a side of the light exit window and configured to emit light in directions away from the light exit window, each linear light source extending parallel to a linear axis; a reflector positioned opposite the light exit window and configured to receive a majority of the light emitted by the one or more linear light sources.

The reflector comprises a diffusive reflective surface configured to perform diffusive reflection on received light; and a plurality of microstructures positioned between the one or more linear light sources and the diffusive reflective surface, the plurality of microstructures or a lightguide within which the plurality of microstructures are formed, being configured to redirect a first portion of light directly received from the one or more linear light sources such that, for each light ray in the first portion of light, the angle, within a cross-sectional plane perpendicular to the linear axis, between the direction of said light ray before being redirected using the plurality of microstructures and the direction of said light ray after being redirected using the plurality of microstructures is from 140°to 180°.

The first portion of light comprises no less than 30% of the light directly received from the one or more linear light sources.

The proposed luminaire makes use of a microstructures to achieve a batwing-like distribution of light output from the light exit window of the luminaire. In particular, by positioning light sources to the side of the light exit window, and reflecting a portion of emitted light to undergo a directional angle change of from 140° to 180° (but not equal to 180°), then a batwing shaped light distribution can be achieved. By preventing the first portion of light from undergoing a reflection of 180°, reabsorption of the light by the light source (or the surrounding chip) can be avoided or reduced.

A batwing light distribution is a light distribution that has at least two peaks displaced from the optical axis (of the luminaire). In particular, a batwing distribution may have at least one peak that lies between 20° to 50° offset from the optical axis.

Batwing light distributions thereby facilitate more light at wider angles from the optical axis than at smaller angles, particularly compared to existing solutions that produce Lambertian distribution of light. This approach provides illumination of a larger environment or volume that previous solutions. Thus, a single luminaire is able to illuminate a larger area more effectively. This mechanism can be exploited to reduce a number of luminaires required to illuminate a large volume or region, e.g., a large room.

The plurality of microstructures may comprise a plurality of retroreflective microstructures configured to perform retroreflection of light. Such retroreflective microstructures are configurable to change the angle of received light by between 140° and 180°, to thereby achieve the underlying concept.

In some examples, each of the plurality of microstructures comprises a spherical ball for redirecting received light. This provides an approach for easy manufacture of a luminaire, as microspheres (i.e., microstructures in the shape of a spherical ball) can be produced on a mass scale and are commonly found in other industries (such as those produced for the sandblasting industry). In this way, existing structures can be repurposed to perform a new function.

In some examples, each of the plurality of microstructures comprises a triangular prism for reflecting light. This embodiment provides a microstructure arrangement having easily controllable reflection characteristics that can be readily defined and controlled by a designer of the luminaire. More flexible design choice of a light distribution is therefore facilitated with this embodiment.

In some examples, reflector comprises a white substrate coating the diffusive reflective surface, wherein each microstructure is partially embedded in the white substrate. Use of a white substrate to carry the microstructures provides a simple and intuitive approach for manufacturing the luminaire. As the substrate is white, loss of light by absorption is reduced.

In some examples, the reflector comprises a sheet that carries each microstructure. A sheet carrying microstructures can be formed in a mass industrial process. The use of a sheet also increases an ease of installing or assembling the luminaire without the need for specialist equipment, meaning that the luminaire could potentially be installed on site for increased flexibility of assembly.

In some examples, the sheet comprises a first surface, that carries each microstructure, and a second surface, opposite to the first surface, configured to transmit received light.

In at least one embodiment, the first surface faces the diffusive reflective structure; and the plurality of microstructures is configured to redirect the first portion of light using reflection. This provides a technique for controlling the light distribution using reflection, allowing for increased control over the beam shape.

In at least one embodiment, the first surface faces away from the diffusive reflective structure; and the plurality of microstructures is configured to redirect the first portion of light using refraction, after the first portion of light has undergone diffusive reflection by the diffusive reflective structure.

In some examples, the one or more linear light sources comprises at least a first linear light source and a second linear light source mutually positioned on either side (i.e. opposite sides) of the light exit window; the one or more linear light sources and/or reflector are configured such that: a majority of light emitted by the first linear light source is incident on a first portion of the reflector, the first portion of the reflector being located more proximate to the second linear light source than the first linear light source; and a majority of light emitted by the second linear light source is incident upon a second portion of the reflector, the second portion of the reflector being located more proximate to the first linear light source than the second linear light source. To attain this specified incidence, the first and/or second light source may be side emitters or may be arranged in a tilted orientation such that their main emission direction is towards the reflector portion on the opposite side of the reflector associated with the light source.

This technique increases the amount of light that is incident upon the microstructures at nearly perpendicular angles, and therefore increases the intensity of the peaks of the batwing-like light distribution.

In some embodiments, the reflector comprises the lightguide wherein the plurality of microstructures are formed, optically coupled to the one or more light linear sources so as to receive the light from the one or more linear light sources. Use of a lightguide provides a mechanism for improved control over the distribution of light output by the luminaire. In particular, the lightguide can be specifically designed to control the redirection of light emitted by the light source(s) to achieve the desired batwing function, thereto, typically the size of the microstructures increases with increasing distance from the light sources and/or the density of the microstructures is increasing with increasing distance from the light sources.

Preferably, the first portion of light comprises no less than 50% of the light received from the one or more linear light sources. This can be achieved through appropriate design, positioning and material selection of the microstructures.

In some examples, the first portion of light comprises no more than 75% of the light received from the one or more linear light sources. This embodiment ensures that at least some of the light that is emitted by the light source is distributed outside of the batwing peaks, for more effective and uniform illumination.

In some examples, the light exit window lies in a first plane; and each of the one or more linear light sources is configured to only emit light in directions that avoid passing through the first plane. This embodiment prevents light emitted by the light source(s) from directly entering an individual's eye, reducing glare and irritation.

In some examples, each of the microstructures has a refractive index of between 1.4 and 1.9. Embodiments recognize that materials with such refractive indices are capable of performing the desired angular change of received light using microstructures.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a generic luminaire;

FIG. 2 illustrates a luminaire according to a first embodiment;

FIG. 3 illustrates a first reflector;

FIG. 4 illustrates a light distribution of a luminaire having the first reflector;

FIG. 5 illustrates a second reflector;

FIG. 6 illustrates a light distribution of a luminaire having the second reflector;

FIG. 7 illustrates a third reflector;

FIG. 8 illustrates a light distribution of a luminaire having the third reflector;

FIG. 9 illustrates the luminaire according to the first embodiment;

FIG. 10 illustrates an alternative shape for a reflector;

FIG. 11 illustrates a luminaire having the reflector with the alternative shape;

FIGS. 12A-B illustrate luminaires according to second embodiments;

FIG. 13 illustrates a light distribution of the luminaire according to the second embodiment.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The present disclosure provides an improved luminaire having one or more linear light sources. A reflector carries microstructures that receive a portion of light emitted by each light source and redirect the received light such that it undergoes an angular change of from 140° up to, but not including, 180°. The microstructures are positioned between the light source(s) and a diffusive reflective surface.

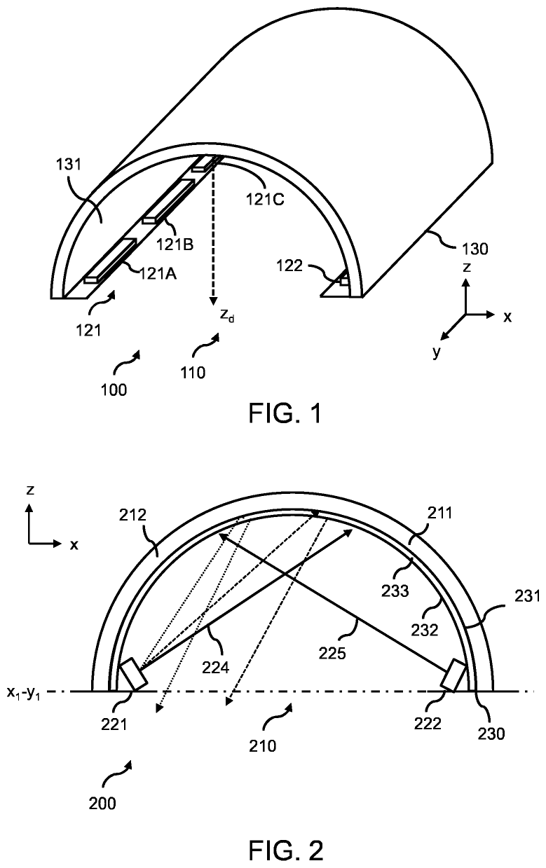

FIG. 1 illustrates a generic luminaire 100 for the purposes of contextual understanding. Dimension x, y, z are illustrated for the sake of improved clarity.

The luminaire 100 comprises a light exit window 110, one or more linear light source 121, 122 and a reflector 130.

The light exit window 110 lies in a first plane, e.g., a plane lying in the x-y dimension. The light exit window 110 is an element that is configured to allow the transmission of light therethrough and may, for instance, comprise an aperture/gap (as illustrated) or a piece of transparent or translucent material such as glass or one or more polymers.

The one or more linear light sources 121, 122 are positioned to a side of the light exit window. In the illustrated example, the one or more linear light sources comprises a first linear light source 121 and a second linear light source 122, mutually positioned on either side of the light exit window 110. Each linear light is configured to extend in a direction that is parallel to a linear axis y.

Examples of linear light sources 121, 122 are well known to the skilled person, and include a linear array of LEDs, an LED strip, a tubular LED or other similar linear sources of light. As illustrated in FIG. 1, each linear light source 121, 122 may be formed of a series or linear array of discrete sub-sources 121A, 121B, 121C of lights (e.g., LEDs or OLEDs). However, this is not essential, and the linear light source may instead comprise a single uniform light source.

Each linear light source 121, 122 is configured to emit light in directions away from the light exit window. In particular, each linear light source 121, 122 may only emit light in directions away from the light exit window, i.e., so that any light emitted by the linear light sources does not directly intersect light exit window and/or a plane in which the light exit window lies.

More specifically, each linear light source 121, 122 may be configured to emit light in directions towards the reflector 130.

The reflector 130 is configured to reflect light emitted by each linear light source 121, 122 towards the light exit window 110.

Historically, it is known for the reflector 130 to comprise a diffusive reflective surface 131 that is configured to perform diffusive reflection on received light. In this way, light emitted by each linear light source undergoes diffusive reflection by the diffusive reflective surface 131. The diffusively reflected light will then be output via the light exit window 110.

In use, the luminaire 100 is commonly positioned in or adjacent to a ceiling, such that each linear light source is configured to emit light towards the ceiling. Put another way, the linear light sources may be upwardly facing light sources. The reflector performs diffusive reflection of the received light, in order to provide diffuse downlighting of an environment below the ceiling.

It has been identified that it is extremely difficult to perform any beamshaping with existing luminaire configurations. This can lead to large amounts of light being emitted at relatively high angles (e.g., >65°) with respect to a vertical downward axis Zd. This can cause significant glare to an individual in the environment illuminated by the luminaire.

The present disclosure provides modifications to the luminaire 100 to facilitate improved lighting characteristics.

The proposed approach provides techniques for providing a luminaire having a batwing light distribution, e.g., a light distribution having suppressed light intensity at a center of the light distribution. Batwing distributions are of particular interest for multiple reasons. In particular, batwing light distributions distribute more light at wide angles compared to other solutions (e.g., compared to Lambertian distributions). This allows for more efficient illumination of a large environment, thereby reduces the number of luminaires needed to illuminate a large environment significantly. This results in quicker and easier installation, requiring substantially less material to illuminate a same environment as conventional solutions and hence provide a more sustainable lighting solution.

In particular, it is herein proposed to provide a plurality of microstructures between the linear light source(s) 121, 122 and the reflector 130 for performing beam-shaping or light ray control. More specifically, each microstructure is configured to redirect at least some of the received rays of light so that the difference in ray angle (within a plane z-x) before redirection and after redirection is between 140° and 180° (but not equal to 180°).

Various embodiments for forming and positioning the plurality of microstructures are envisaged, a number of which are described below.

FIG. 2 illustrates a luminaire 200 according to a first embodiment.

The basic structure of the luminaire 200 is similar to that of the generic luminaire 100, illustrated in FIG. 1. Thus, the luminaire 200 comprises a light exit window 210, one or more linear light source 221, 222 and a reflector 230 (with a diffusive reflective surface 231). As shown, the first 221 and second light source 222 are arranged in a tilted orientation with respect to the light exit window 210 such that their main emission direction 224, 225 is towards the reflector portion 211, 212 on the opposite side of the light exit window 210, associated with the first 221 light source respectively with the second light source 222.

The luminaire 200 differs from the generic luminaire 100 in that the reflector 230 (in addition to the diffusive reflective surface 231, which is mounted on a supporting structure 235) comprises a plurality 232 of microstructures positioned between the one or more linear light sources and the diffusive reflective surface.

The plurality of microstructures are configured to redirect a first portion of light directly received from the one or more linear light sources. More specifically, for each light ray in the first portion of light, the plurality of microstructures are configured to redirect the light ray such that (in a plane z-x) at least some of the redirected light undergoes an angular change of from 140° to 180° (but not including 180°).

The plane z-x lies perpendicular to the linear axis, i.e., the linear axis is normal to the plane z-x In the illustrated example, the linear axis goes into or out of the page. As previously explained, each linear light source 221, 222 lies along a direction parallel to the linear axis. In this way, the plane z-x is also perpendicular to the direction along which any linear light source(s) lie.

In this embodiment, the plurality of microstructures comprises a plurality of retroreflective microstructures configured to perform retroreflection of light or off-axis retroreflection of light. Examples of suitable microstructures include spherical balls (i.e., microspheres) and/or triangular prisms, although other examples will be apparent to the skilled person.

In a first variant of the first embodiment, the reflector comprises a white substrate 233 coating the diffusive reflective surface 231, wherein each microstructure is partially embedded in the white substrate. Examples of white substrates include paint or other coatings for a diffusive reflective surface.

In a second variant of the first embodiment, the reflector comprises a sheet that carries each microstructure. Example sheets include polymeric sheets or the like. In such embodiments, each microstructure may be integrally formed with the sheet.

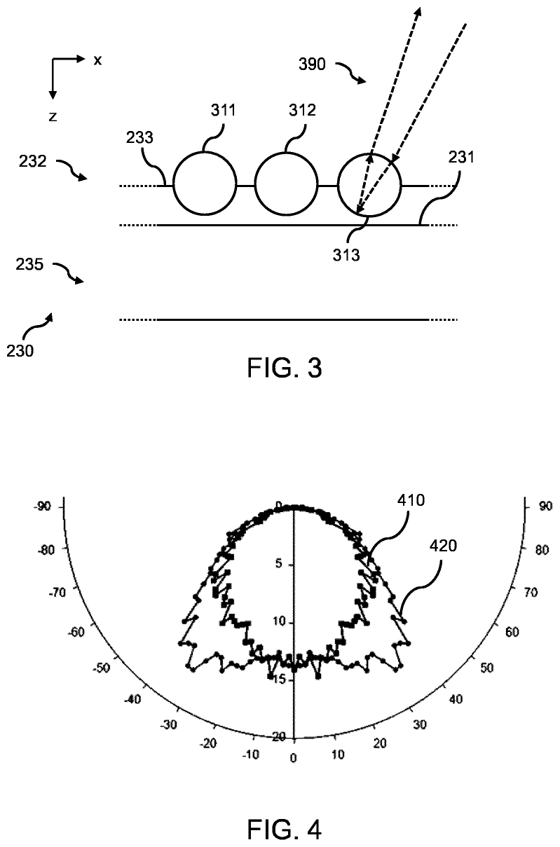

FIG. 3 illustrates an enlarged view of a portion of a first reflector 230 for use in a first variant of the first embodiment.

In this example, the reflector 230 comprises a white substrate 233 that coats the diffusive reflective surface 231. The diffusive reflective surface may be formed on a supporting structure 235. The reflector 230 also comprises a plurality 232 of microstructures 311, 312, 313 (of which only a small selection is illustrated) that are (partially) embedded in the white substrate 233. Thus, the white substrate 233 and the plurality 232 of microstructures 311, 312, 313 together form a microstructure layer.

In this way, the microstructure layer is directly coupled to the diffusive reflective surface. In some alternative examples, the white substrate 233 itself may be considered to provide the diffusive reflective surface.

Each microstructure 311, 312, 313 is here embodied as a microstructure having a spherical shape, i.e., a microsphere. In other words, each of the plurality of microstructures comprises a spherical ball for redirecting received light. When such particles are partially embedded in a reflective (white) substrate, then at least some of the incident light is concentrated to a spot that can hit the boundary between the substrate and the sphere. That light is collimated by the sphere and exits the sphere in the same direction as where it came from. Hence, retroreflection occurs.

Approaches for producing microspheres are well known, and are considered to be cost effective and simple to perform. Microspheres have historically found a use in sand blasting techniques.

One way of preparing a proposed microstructure layer is to initially paint a surface with a white paint. Whilst the paint is still wet, microspheres are poured over the surface, such that they partially sink into the paint. The depth to which the microspheres sink will depend on the mass density of the paint and the microspheres, the surface tension, the viscosity and the thickness of the paint layer as well as the final velocity of the falling microspheres. Experimental practice has identified that applying a thin layer of white Latex paint with a roller and subsequently pouring glass microspheres from about a 10 cm distance results in the desired partial embedding. However, the precise approach or technique used can vary in practice.

Thus, there is provided a white substrate 233 with partially embedded microspheres 311, 312, 313. The microspheres are configured to face the inside of the cavity, i.e., face away from the diffusive reflective surface.

The microspheres 311, 312, 313 perform the function of reflecting a portion of received light so that, after reflection, the angle of the reflected portion of light is between 140° and 180° (but not equal to 180°) with respect to the angle of the received light. This is conceptually illustrated by an exemplary light ray 390.

The microspheres 311, 312, 313 may have a refractive index of between 1.4 and 1.9. The lower the refractive index, the more diffuse the light output by the luminaire will be. For instance, for a whitish look-and feel (i.e., desirable diffuse light), a refractive index around 1.5 would be better whilst a refractive index of around 1.8 would provide improved beam control.

The microspheres 311, 312, 313 may be replaced by other forms of microstructures, such as those having a polyhedral shape (e.g., tetrahedrons, pyramids and so on).

The packing density of the microstructures will determine the amount of light that is reflected in this manner. A sparingly covered surface will undergo almost completely diffuse reflection (e.g., from the white substrate 233 and/or the diffusive reflective surface), while densely packed microstructures, such as equally sized microspheres in a hexagonal pattern, will perform the above-identified redirection of light.

FIG. 4 illustrates the beam shape or light distribution of light output by a luminaire having the reflector embodied as illustrated in FIG. 3, i.e., comprising a white substrate in which microspheres are partially embedded.

A first curve 410 illustrates the light distribution in an XZ-plane and a second curve 420 illustrates the light distribution in a YZ-plane. As will be apparent from the illustrated light distribution, the light distribution in at least one of these planes takes the form of a batwing. This is as a result of at least some of the redirected light undergoing an angular change of from 140° to 180° (but not including 180°).

This reduces a glare of light output by the luminaire.

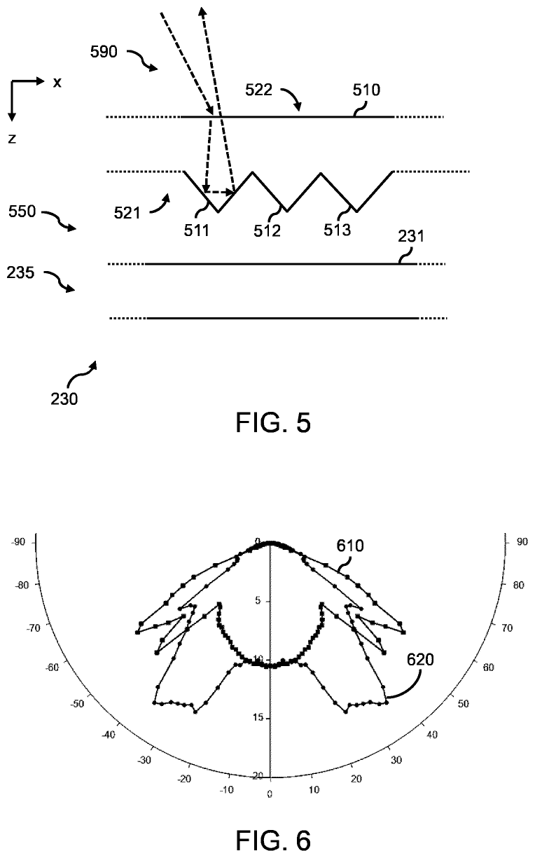

FIG. 5 illustrates an enlarged view of a portion of a second reflector 230 for use in a second variant of the first embodiment.

In this variant, the reflector 230 comprises a sheet 510 or foil that carries each microstructure 511, 512, 513. In particular, each microstructure may be integrally formed in the sheet 510. The sheet 510 may be separated or distance from the diffusive reflective surface 231, e.g., by an air gap 550.

In the illustrated example, each microstructure 511, 512, 513 is a prism, particularly a triangular prism. The sheet 510 may therefore be a prism foil, examples of which are known in the art. For instance, prism foils are commonly used in LCD televisions or monitors. An example of a suitable foil is produced by 3M™: Brightness Enhancement film III, type BEF III 90/50-T.

The sheet 510 is positioned near the diffusive reflective surface 231 such that the microstructures 511, 512, 513 face towards the diffusive reflective surface. In other words, each microstructure extends towards the diffusive reflective surface 231. In this way, the sheet 510 comprises a first surface 521, that carries each microstructure 511, 512, 513, and a second surface 522, opposite to the first surface, configured to transmit received light. In this, example, the first surface 521 faces towards the diffusive reflective structure.

When configured in this way (and where the microstructures have a polyhedral shape such as a triangular prism), each microstructure directs a portion of received light to change its angle by between 140° and 180° (not including 180°). This is conceptually illustrated by the exemplary light ray 590.

Preferably, the top angle of each triangular prism 511, 512, 513 is around 80°, e.g., from 80° to 90° inclusive, and more preferably from 80° to 85° inclusive. This has been identified as providing improved redirection of received light with respect to the desired angle range.

Preferably, the microstructures (and therefore, preferably, the entire sheet 510) is formed of a material having a refractive index of less than 1.58, e.g., between 1.49 and 1.58. This has been identified as producing improved redirection of light to change the angle of within the desired angle range. Appropriate materials for forming the microstructure having such refractive indices include: PMMA, polystyrene, amorphous PE/PP, polycarbonate etc.

Of course, it is not essential that all of the light incident upon the sheet 510 undergoes such an angular change. Rather, another portion of the received light will be transmitted through the sheet 510 diffusive reflective surface. This light will be diffusively reflected back through the sheet 510 to escape the luminaire. This characteristic creates suitably diffuse light for illuminating an environment.

FIG. 6 illustrates the beam shape or light distribution of light output by a luminaire having the reflector embodied as illustrated in FIG. 5, i.e., comprising a sheet with a plurality of microstructures, in the form of triangular prisms, facing a diffusive reflective surface of the reflector.

A first curve 610 illustrates the light distribution in an XZ-plane and a second curve 620 illustrates the light distribution in a YZ-plane. As will be apparent from the illustrated light distribution, the light distribution in these planes takes the form of a batwing. This is as a result of at least some of the redirected light undergoing an angular change of from 140° to 180° (but not including 180°).

This reduces a glare of light output by the luminaire.

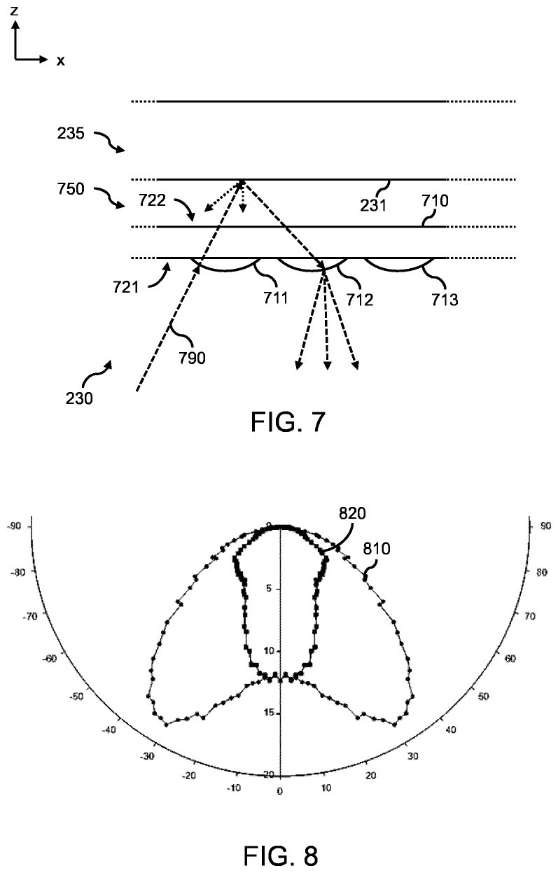

FIG. 7 illustrates an enlarged view of a portion of a third reflector 230 for use in a second variant of the first embodiment.

In this approach, the reflector 230 again comprises a sheet 710 or foil that carries each microstructure 711, 712, 713. Each microstructure may be integrally formed or otherwise coupled to the sheet 710. The sheet 710 may be separated or distance from the diffusive reflective surface 231, e.g., by an air gap 750. However, this spacing is not critical and the sheet may, in some examples, make mechanical contact with the diffusive reflective surface.

The microstructures 711, 712, 713 are configured to perform beam shaping of light reflected from the diffusive reflective surface 231. In particular, the microstructures 711, 712, 713 can be arranged such that a light beam from the diffusive reflective surface is reshaped into a certain intensity distribution. This distribution can be a collimated beam, a wider, more diffuse beam, or even a batwing shaped beam, an angle bending beam, ring-shaped beam, office compliant beam etc.

Such sheets/foils should be used in a specific orientation relative to the light source and the object to be illuminated. Conventionally, the correct orientation is such that the smooth side of the foil is towards the light source, and the rough, micro-structured side faces towards the region to be illuminated.

As shown in FIG. 7, the sheet 710 is oriented/positioned such that light 790 emitted from the light source(s) (not shown) pass the sheet 710 in the “wrong” direction. In this way, a large portion of the light will transmit through the sheet 710 and hit the diffusive reflective surface 231. Because the diffusive reflective surface performs diffusive reflection of the received light, the precise beam shape of the light exiting the sheet 710 as it travels towards the diffusive reflective surface is immaterial. After the light hits the diffusive reflective surface 231, it undergoes diffusive reflection (e.g., is redirected with a Lambertian distribution). This reflected light then hits the sheet 710 again, but this time in the “correct” direction. The beam shaping effect of the microstructures thereafter shapes the light beam based on the configuration of the microstructures 711, 712, 713.

In this way, the sheet 710 comprises a first surface 721, that carries each microstructure 711, 712, 713, and a second surface 722, opposite to the first surface, configured to transmit received light. In this, example, the first surface 721 faces away from the diffusive reflective structure.

FIG. 8 illustrates the beam shape or light distribution of light output by a luminaire having the reflector embodied as illustrated in FIG. 7, i.e., comprising a sheet with a plurality of microstructures, for performing beamshaping, facing away from the diffusive reflective surface of the reflector.

A first curve 810 illustrates the light distribution in an XZ-plane and a second curve 820 illustrates the light distribution in a YZ-plane. As will be apparent from the illustrated light distribution, the light distribution in at least one of these planes takes the form of a batwing. This is as a result of at least some of the redirected light undergoing an angular change of from 140° to 180° (but not including 180°), resulting from the beamshaping performed on the diffusively reflected light.

This reduces a glare of light output by the luminaire.

In any above described embodiment, it is preferred that each linear light source and/or the reflector is positioned or otherwise configured such that a majority of light emitted by the linear light source is incident on a portion of the reflector on an opposite side of the luminaire. This will increase the percentage of light rays hitting the plurality of microstructures at close to perpendicular angles, and therefore the amount of light that undergoes an angular change of from 140° to 180° (but not including 180°). More particularly, this approach further increases the peak intensity of the peaks in a batwing distribution.

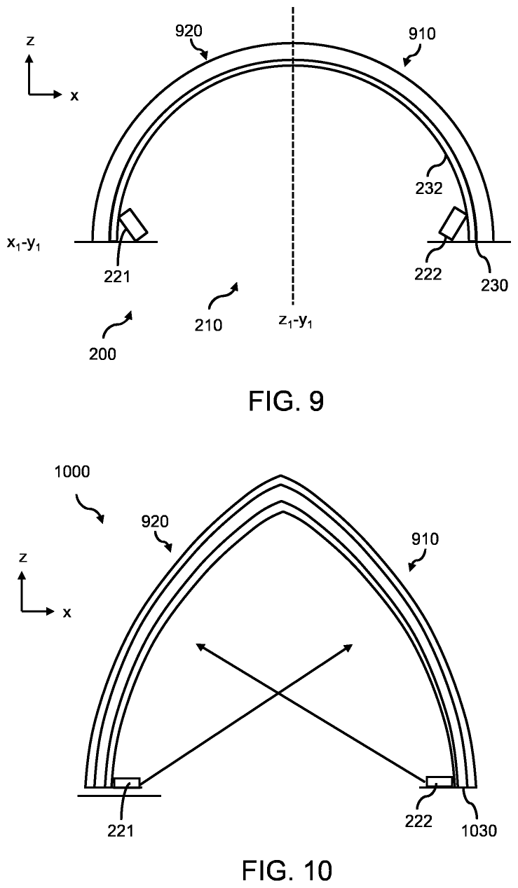

FIG. 9 illustrates this concept. In particular, the luminaire 200 comprises a first linear light source 221 and a second linear light source 222. The reflector is conceptually divided into at least a first portion 910 and a second portion 920. The first portion 910 is closer to the first linear light source 221 than the second linear light source 222. The second portion 920 is closer to the second linear light source 222 than the first linear light source.

The first portion 910 may, for instance, comprise a portion of the reflector 230 that lies on one side of a bisecting plane z₁-y₁ that bisects the luminaire in two (e.g., and intersects the linear axis y). The second portion 920 may comprise the portion of the reflector on the other side of this bisecting plane z₁-y₁,

The light sources 221, 222 and/or the reflector 230 are configured such that a majority of the light emitted by the first linear light source 221 is incident upon the first portion 910 of the reflector 230. Similarly, the light sources 221, 222 and/or the reflector 230 are configured such that a majority of the light emitted by the second linear light source 222 is incident upon the second portion 920 of the reflector 230.

One approach for directing the light emitted by a light source appropriately is through use of light optics, e.g., that perform collimation of light. Example techniques are well known in the art, and make use of lenses, mirrors, compound parabolic concentrators (CPCs) and so on. In particular, collimating means used in examples can include an extruded TIR lens, a half cylinder lens, a mirror, or combinations thereof, as well as individual lenses and/or mirrors for each light source. If used, it is preferable that the collimation be performed using one or more extruded lenses for reduced costs and ease of assembly.

Another approach for directing the light emitted by a light source appropriately is to suitable angle or orient each light source. For instance, each light source may be oriented such that a majority of emitted light (based on a known light distribution for the light source) is directed towards the opposite portion of the reflector.

Yet another approach may make use of one or more baffles or light blocking elements to block light emission onto a nearest portion of the reflector 230.

Any combination of these approaches can be used to advantage.

Another technique to increase the intensity of the peaks of a batwing light distribution is to modify the shape of the reflector. Previous examples of reflectors are generally shaped to have a cross-sectional shape (in a plane perpendicular to a linear axis) similar to semi-circular arc or an annulus sector. However, alternative shapes will increase the number of rays that intersect with the plurality of microstructures at close to perpendicular angles, and therefore the amount of light that undergoes an angular change of from 140° to 180° (but not including 180°).

In particular examples, the reflector is configured to have cross-sectional shape (in a plane perpendicular to a linear axis) analogous to an elliptic annulus sector or a pointed arc.

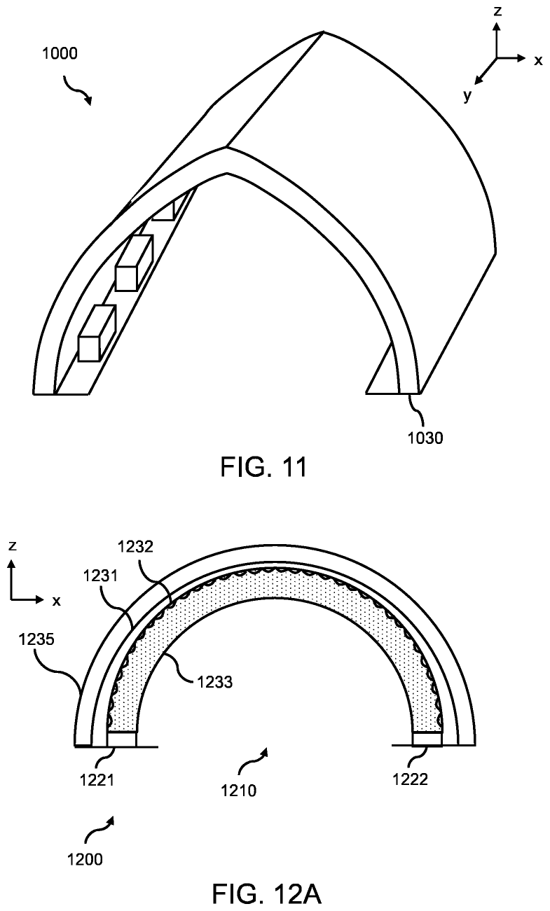

FIGS. 10 and 11 illustrate an exemplary luminaire 1000 having a cross-sectional shape in the form of a pointed arc or pointed arch. Thus, the cross-sectional shape of the reflector 1030 of such a luminaire resembles a pointed arch, an ogival arch or a Gothic arch. The light sources 221 and 222 in FIGS. 10 and 11 are side emitters such that a majority of light emitted by the first linear light 221 source is incident on a first portion 910 of the reflector 1030. The first portion 910 of the reflector 1030 is located more proximate to the second linear light source 222 than the first linear light source 221. A majority of light emitted by the second linear light source 222 is incident upon a second portion 920 of the reflector 1030. The second portion 920 of the reflector 1030 being located more proximate to the first linear light source 221 than the second linear light source 222.

Other characteristics of the luminaire may be otherwise identical to any embodiment herein described.

As previously explained, it would be preferable if the light emitted by the light source(s) does not directly escape via the light exit window, e.g., so that the room occupant is unable to directly see the light from the light source(s). Such light would be a nuisance and increases glare.

Approaches for avoiding any light emitted from the light source(s) from passing directly through the light exit window include orientating the light source(s), e.g., to be angled towards the upward direction, appropriate design of any optical elements of the light source(s) and/or the use of one or more small baffles (between the light source and the light exit window) for light blocking or recycling.

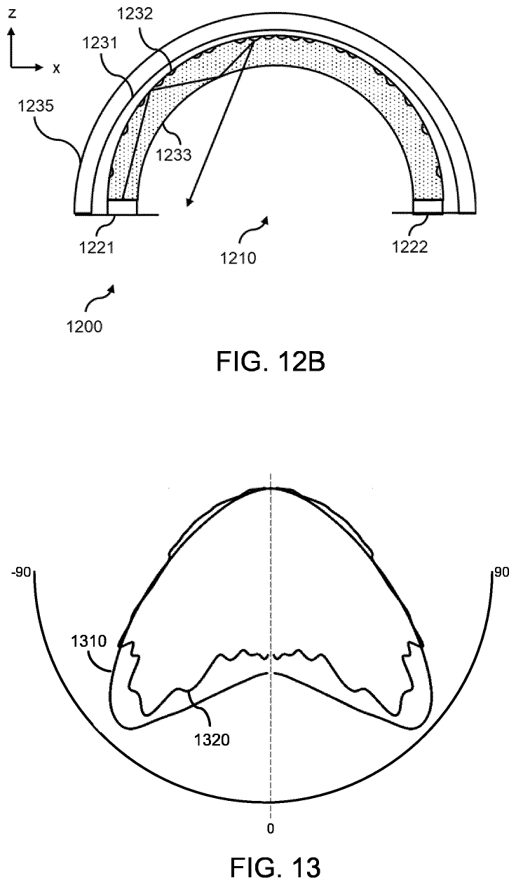

FIGS. 12A-B illustrate a luminaire 1200 according to second embodiments.

The basic structure of the luminaire 1200 is similar to that of the generic luminaire 100, illustrated in FIG. 1. Thus, the luminaire 1200 comprises a light exit window 1210, one or more linear light source 1221, 1222 and a reflector 1230.

The luminaire 1200 differs from the generic luminaire 100 in that the reflector 1230 (in addition to the diffusive reflective surface 1231, which is mounted on a supporting structure 1235) comprises a plurality 1232 of microstructures positioned between the one or more linear light sources and the diffusive reflective surface.

More particularly, the reflector 1230 comprises a lightguide 1233 optically coupled to the one or more light linear sources so as to receive the light from the one or more linear light sources. The plurality of microstructures 1232 are formed within the lightguide 1233. In FIG. 12A the density of the microstructures is uniform over the length of the lightguide, yet the size of the microstructures increases with increasing distance from the light sources. In FIG. 12B the density of the microstructures is increasing with increasing distance from the light sources. Both measures aim at a providing the luminaire a batwing-like beam profile of the majority of light, i.e. the angle, within a cross-sectional plane perpendicular to the linear axis, between the direction of said light ray before being redirected using the plurality of microstructures and the direction of said light ray after being redirected using the plurality of microstructures is in the range from 140° to 180°.

The lightguide 1233 performs a same or similar function to the reflectors of any previously described embodiment. In particular, the lightguide is configured to redirect a first portion of light received from the light sources to undergo a directional angle change of between 140° and 180° (not including 180°). The first portion of light comprises no less than 30% of the light directly received from the one or more linear light sources.

In operation, light emitted by the linear light source(s) 1221, 1222 is coupled in the lightguide 1233 at the edges. In order to couple out the light from the lightguide with the desired change in directionality, microstructures 1232 (such as indented cones or prisms) can be engraved or molded on the outer surface of the lightguide 1233, e.g., at a surface facing the diffusive reflective surface 1231. Alternatively and/or additionally, microstructures (not shown) may protrude outwardly from the lightguide 1233 at a surface facing away from the diffusive reflective surface 1231, i.e., a surface facing towards the light exit window.

In this way, microstructures control the redirection of light received by the lightguide 1233.

In the context of this embodiment, the lightguide 1233 may be positioned such that light emitted by each light source is directly coupled into the lightguide. Alternatively, the lightguide 1233 may be separated from each light source, e.g., so that there is an air gap between the lightguide 1233 and the light source, such that light emitted by each light source traverses an air gap before entering the lightguide.

In either scenario, the angle of a light ray before redirection is the angle at which the light ray is emitted out from the light source.

If the microstructures are cones or prisms, the top angle of the cones or prisms determine the main exit angle of the light. The size of the cones or prisms determine the percentage of light is extracted. By tuning the shape of the lightguide, the top angle and/or the size of the cones or prisms, one can accomplish a uniform light distribution output by the luminaire and provide a batwing light distribution.

Of course, the index of refraction (n) of the lightguide also has an influence on the light distribution. Higher n-values keep more light inside the lightguide, and the light deflection angles from the cones/prisms can be larger due to the higher TIR-angles.

It is preferred that the lightguide also absorbs as little light as possible. Examples of suitable materials for forming the include PMMA (e.g., Röhm 7N, 8N, n=1.49, very low absorption) or polycarbonate (e.g., Idemitsu Tarflon LVE1700, or Sabic 2180T, n=1.58).

The lightguide 1233 may appear glossy due to Fresnel reflections on the interface between the lightguide and the air. To reduce this effect, the lightguide 1233 can be coated with an anti-reflection coating on the surface facing the light exit window.

Alternatively, the surface facing the light exit window may be roughened slightly to reduce the Fresnel reflections, but not enough to disturb the batwing distribution.

FIG. 13 illustrates the beam shape or light distribution of light output by a luminaire having the reflector embodied as illustrated in FIGS. 12A-B, i.e., comprising a lightguide carrying microstructures.

A first curve 1310 illustrates a target or ideal light distribution in an XZ-plane and a second curve 1320 illustrates the actualized distribution in the XZ-plane. As will be apparent from the illustrated light distribution, the actualized light distribution takes the form of a batwing. This is as a result of at least some of the redirected light undergoing an angular change of from 140° to 180° (but not including 180°), resulting from the beamshaping performed on the diffusively reflected light.

This reduces a glare of light output by the luminaire.

In any above described embodiment, the light source may comprise a plurality of differently colored light emitting elements. For instance, different light emitting elements may emit one or more of: warm white, cold white, RGB, tuneable white or cyan LEDs (e.g., for higher Melanopic Daylight Efficacy Ratio), without the undesirable effect of colored spots on the inside of the reflector, as the proposed mechanism facilitates good color mixing. In above described and illustrated embodiments, each light source is positioned to a side of a single light exit window. In an alternative example, one or more light sources may be positioned between two separate light windows, e.g., the light source may act to sub-divide a single light exit window into multiple light exit windows.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A luminaire comprising:
a light exit window;
one or more linear light sources positioned to a side of the light exit window and configured to emit light in directions away from the light exit window, each linear light source extending parallel to a linear axis;
a reflector positioned opposite the light exit window and configured to receive a majority of the light emitted by the one or more linear light sources, wherein the reflector comprises:
a diffusive reflective surface configured to perform diffusive reflection on received light; and
a plurality of microstructures positioned between the one or more linear light sources and the diffusive reflective surface, the plurality of microstructures or a lightguide within which the plurality of microstructures are formed, being configured to redirect a first portion of light directly received from the one or more linear light sources such that, for each light ray in the first portion of light, the angle, within a cross-sectional plane perpendicular to the linear axis, between the direction of said light ray before being redirected using the plurality of microstructures and the direction of said light ray after being redirected using the plurality of microstructures is from 140° to 180°,
wherein the first portion of light comprises no less than 30% of the light directly received from the one or more linear light sources.

2. The luminaire of claim 1, wherein the plurality of microstructures comprises a plurality of retroreflective microstructures configured to perform retroreflection of light.

3. The luminaire of claim 2, wherein each of the plurality of microstructures comprises a spherical ball for redirecting received light.

4. The luminaire of claim 2, wherein each of the plurality of microstructures comprises a triangular prism for reflecting light.

5. The luminaire of claim 1, wherein the reflector comprises a white substrate coating the diffusive reflective surface, wherein each microstructure is partially embedded in the white substrate.

6. The luminaire of any of claim 1, wherein the reflector comprises a sheet that carries each microstructure.

7. The luminaire of claim 6, wherein the sheet comprises a first surface, that carries each microstructure, and a second surface, opposite to the first surface, configured to transmit received light.

8. The luminaire of claim 7, wherein:
the first surface faces the diffusive reflective structure; and
the plurality of microstructures is configured to redirect the first portion of light using reflection.

9. The luminaire of claim 7, wherein:
the first surface faces away from the diffusive reflective structure; and
the plurality of microstructures is configured to redirect the first portion of light using refraction, after the first portion of light has undergone diffusive reflection by the diffusive reflective structure.

10. The luminaire of claim 1, wherein:
the one or more linear light sources comprises at least a first linear light source and a second linear light source mutually positioned on either side of the light exit window;
the one or more linear light sources and/or reflector are configured such that:
a majority of light emitted by the first linear light source is incident on a first portion of the reflector, the first portion of the reflector being located more proximate to the second linear light source than the first linear light source; and
a majority of light emitted by the second linear light source is incident upon a second portion of the reflector, the second portion of the reflector being located more proximate to the first linear light source than the second linear light source.

11. The luminaire of claim 1, wherein the reflector comprises the lightguide, wherein the plurality of microstructures are formed, optically coupled to the one or more light linear sources so as to receive the light from the one or more linear light sources,.

12. The luminaire of claim 1, wherein the first portion of light comprises no less than 50% of the light received from the one or more linear light sources.

13. The luminaire of claim 1, wherein the first portion of light comprises no more than 75% of the light received from the one or more linear light sources.

14. The luminaire of claim 1, wherein:
the light exit window lies in a first plane; and
each of the one or more linear light sources is configured to only emit light in directions that avoid passing through the first plane.

15. The luminaire of claim 1, wherein each of the microstructures has a refractive index of between 1.4 and 1.9.
